(19) United States
(12) Patent Application Publication
(10) Pub. No.: US 2008/0018681 A1
(43) Pub. Date: Jan. 24, 2008

(54) INK-JET SYSTEM AND INK-JET CONTROL METHOD

(75) Inventors: Chih-Jian Lin, Taipei County (TW); Chao-Kai Cheng, Hsinchu County (TW); Chia-Ming Chang, Taipei County (TW); Gian-Hung Liu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/550,805

(22) Filed: Oct. 19, 2006

(30) Foreign Application Priority Data
Jul. 21, 2006 (TW) 95126651

(51) Int. Cl. B41J 29/38

(52) U.S. Cl. 347/10

(57) ABSTRACT

An ink-jet system and an ink-jet control method are provided. The ink-jet system mainly includes an ink-jet head, a feedback unit and a frequency eliminator. The feedback unit provides a feedback signal to the ink-jet head as the ink-jet head performs jet printing. Next, the frequency of the feedback signal is eliminated by the frequency eliminator to produce a driving signal. Then, the ink-jet head is controlled to perform ink-jetting according to the driving signal. The frequency of the feedback signal is higher than that of the driving signal, and the frequency of the feedback signal is divisible by that of the driving signal. The ink-jet system and the ink-jet control method meets high precision and high speed ink-jet requirements and are capable of fabricating patterns with different resolutions.

### CROSS-REFERENCE TO RELATED APPLICATION

This application claims the priority benefit of Taiwan application serial no. 95126651, filed Jul. 21, 2006. All disclosure of the Taiwan application is incorporated herein by reference.

### BACKGROUND OF THE INVENTION

1. Field of Invention

The present invention relates to an ink-jet system and an ink-jet control method, and more particularly, to an ink-jet system and an ink-jet control method that are capable of quickly and exactly controlling the ink-jet speed.

2. Description of Related Art

As the progress of the fabricating process technique, the ink-jetting technique has been widely applied to fabricate various precise elements, such as liquid crystal display, semiconductor element and packaging element (e.g., printed circuit board), based on the advantage that it can be used to fabricate highly precise patterns.

Conventional ink-jet techniques are generally applied to the printer to print pictures or other image outputs. Under the precondition that the quality of the output picture has met with the requirements of the human eyes, it focuses on enhancing the printing speed. Compared with the previous ink-jetting technique, the ink-jetting technique currently used in the industry requires an ink-jet controlling with a precise positioning effect and a high printing speed, in order to output precise patterns and satisfy the production efficiency.

FIG. 1 is a conventional ink-jet technique control method. As shown in FIG. 1, when a motion control is performed to an ink-jet printing platform, a feedback unit such as an optical scale or a rotary encoder outputs a triggering signal 110 to a control chip of the ink-jet head, so as to control a nozzle on the ink-jet head to perform ink-jetting. Generally speaking, the moving speed of the ink-jet printing platform and the speed of ink-jetting must be balanced, that is, the frequency of the triggering signal 110 generated while the ink-jet printing platform moves is required to be smaller than or equal to the maximum operating frequency of the ink-jet controlling, otherwise, the quality of the ink-jetting may be deteriorated.

On the other aspect, if the motion control with a high resolution is selected to make the frequency of the triggering signal be higher than the desired operating frequency of the ink-jet control, the ink-jet head and the triggering signal 110 perform triggering synchronously, such that each pulse signal input to the control chip needs to be processed, and accordingly the processing speed of the control chip is relatively slowed down, thereby affecting the ink-jetting quality and speed. In other words, the moving speed of the ink-jet printing platform is limited by the ink-jet frequency.

Recently, the common method is to employ the triggering signal with a relatively low motion resolution. In FIG. 1, a triggering signal 110 with a relatively low motion resolution, for example, 30 μm, is selected to form the ink-jet pattern with a relatively high resolution (e.g., 10 μm). The mark 120 represents an ink-jet control signal of the ink-jet head, wherein besides the circumstance that the triggering point 122 performs the synchronous triggering according to the triggering signal 110, the following triggering points 124, 126 must be selected through the time slicing between two pulses of the triggering signal 110 performed by the circuit control. As shown in FIG. 1, in order to generate the ink spots with equal intervals, the triggering points of the triggering signal 110 must be spaced with equal intervals. However, since the motion control of the ink-jet printing platform is of a low resolution, and the circuit control is used to select the asynchronously triggered triggering points 124, 126, the triggering points 124, 126 may generate offsets, and the correspondingly generated ink spots are not located on desired positions, so as to result in the non-uniformity of the ink-jetting and defects of the ink-jet pattern, and thereby resulting in the reducing of the yields of the process.

The mark 130 in FIG. 1 represents the distribution of desired ink spot, wherein the ink spots 132, 134 and 136 respectively correspond to the triggering points 122, 124 and 126, and under the ideal state, a successive and uniform ink-jet pattern 152 is formed. Correspondingly, the mark 140 in FIG. 1 represents the distribution of actual ink spot, wherein actually only the ink spot 142 that is synchronously triggered with the triggering point 122 is located on the correct position. Since the low resolution motion control of the ink-jet printing platform may result in the shifting of the triggering points 124, 126, the corresponding ink spots 144 and 146 may offset from the desired positions, so as to form the ink-jet patterns 154 or 156 with defects.

To sum up, the current ink-jet control technique is still restricted by the mutual restrain of the motion resolution and the ink-jet speed of the ink-jet printing platform, such that it is impossible to achieve the optimized ink-jet control with high precision and high speed.

### SUMMARY OF THE INVENTION

The present invention is directed to an ink-jet control method, which meets with high precision and high speed ink-jet requirements and is capable of fabricating patterns with different resolutions.

The present invention is further directed to an ink-jet system, which achieves a high precision and high speed ink-jet control and is capable of fabricating patterns with different resolutions, so it has a relatively high compatibility.

As embodied and broadly described herein, the present invention provides an ink-jet control method, which is suitable for controlling an ink-jet head to perform ink-jetting. In the ink-jet control method, firstly, a feedback signal is provided to the ink-jet head, and then, a driving signal is generated according to the feedback signal. The frequency of the feedback signal is higher than that of the driving signal, and the frequency of the feedback signal is divisible by that of the driving signal. Finally, the ink-jet head is controlled to perform ink-jetting according to the driving signal.

In an embodiment of the present invention, the method of generating the driving signal is that, for example, a flip-flop device or a counter is used to perform a frequency eliminating on the feedback signal.

In an embodiment of the present invention, the feedback signal is generated from a function generator, an optical scale or a rotary encoder that performs the feedback control to the ink-jet head.

In an embodiment of the present invention, the ink-jet head has a nozzle, and after receiving the driving signal, the ink-jet head outputs an ink-jet control signal to the nozzle according to the driving signal.

In an embodiment of the present invention, the ink-jet head has a plurality of nozzles, and after receiving the driving signal, the ink-jet head outputs an ink-jet control signal to each nozzle respectively according to the driving signal.

In an embodiment of the present invention, the ink-jet control signals are synchronized or not synchronized with the driving signal. Moreover, the ink-jet control signals have the same or different phase difference with respect to the driving signal.

In an embodiment of the present invention, when the ink-jet head outputs the ink-jet control signal according to the driving signal, the method further comprises modulating at least one ink-jet control signal, wherein the performed modulation is, for example, an addressable pulse width modulation.

In an embodiment of the present invention, wave forms of the feedback signal, the driving signal and the ink-jet control signal are, for example, a square wave, a sine wave, a triangular wave, a trapezoidal wave or any combination thereof.

The present invention further provides an ink-jet system, which mainly comprises an ink-jet head, a feedback unit and a frequency eliminator. When the ink-jet head performs the ink-jet printing, the feedback unit provides a feedback signal. The frequency eliminator performs the frequency eliminating to the feedback signal and generates a driving signal. Thus, the ink-jet head is controlled to perform ink-jetting according on the driving signal. The frequency of the feedback signal is higher than that of the driving signal, and the frequency of the feedback signal is divisible by that of the driving signal.

In an embodiment of the present invention, the feedback unit is, for example, a function generator, an optical scale or a rotary encoder.

In an embodiment of the present invention, the frequency eliminator is, for example, a flip-flop device or a counter.

In an embodiment of the present invention, the ink-jet head has a nozzle, and after receiving the driving signal, the ink-jet head outputs an ink-jet control signal to the nozzle according to the driving signal. In an embodiment of the present invention, the ink-jet head has a plurality of nozzles, and after receiving the driving signal, the ink-jet head outputs an ink-jet control signal to each nozzle respectively according to the driving signal.

In an embodiment of the present invention, the ink-jet control signals are synchronized or not synchronized with the driving signal. Moreover, the ink-jet control signals have the same or different phase difference with respect to the driving signal.

In an embodiment of the present invention, the ink-jet head further has a modulating unit for modulating at least one ink-jet control signal when outputting the ink-jet control signals. The modulating unit is, for example, an addressable pulse width modulation unit.

In an embodiment of the present invention, wave forms of the feedback signal, the driving signal and the ink-jet control signal are, for example, a square wave, a sine wave, a triangular wave, a trapezoidal wave or any combination thereof.

Based on the above, after the feedback signal is generated in the present invention, firstly, the frequency eliminating is performed to the feedback signal, so as to obtain a driving signal with a desired triggering frequency, and thereby driving the ink-jet head to perform the ink-jetting according to the driving signal. Therefore, each ink spot corresponds to a triggering point of the driving signal, so as to achieve the requirements of the accurate position of the ink spot. Moreover, the frequency eliminating process can be used to avoid the problem of a low processing speed of the chip caused by the excessively high frequency of the triggering signal under the high resolution motion control, so as to be helpful for enhancing the ink-jet speed.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a conventional common ink-jetting technique control method.

FIG. 2 is a block diagram of an ink-jet system according to a preferred embodiment of the present invention.

FIG. 3 shows an ink-jet control method of the present invention that is suitable for being used in the ink-jet system.

FIG. 4 shows a corresponding relationship between the signal and the ink-jet pattern in an ink-jet control method of the present invention.

FIG. 5 shows a corresponding relationship between the signal and the ink-jet pattern in another ink-jet control method of the present invention.

FIGS. 6A and 6B show a corresponding relationship between the signal and the ink-jet pattern in still another ink-jet control method according to the present invention.

FIGS. 7 and 8 respectively show a block diagram and an ink-jet control method of the ink-jet system suitable for the driving method of FIG. 6B.

FIGS. 9A and 9B show a corresponding relationship between the signal and the ink-jet pattern in yet another ink-jet control method of the present invention.

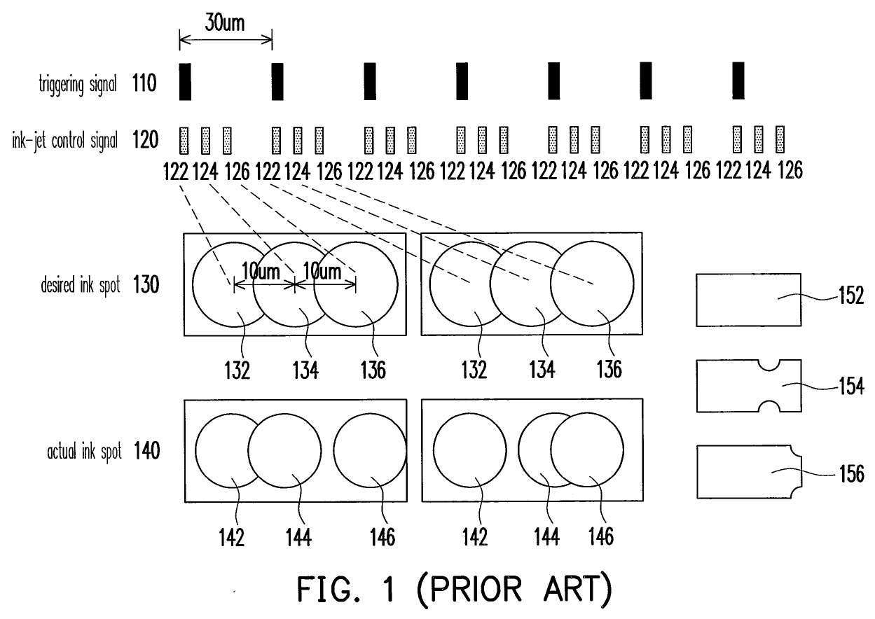

### DESCRIPTION OF EMBODIMENTS

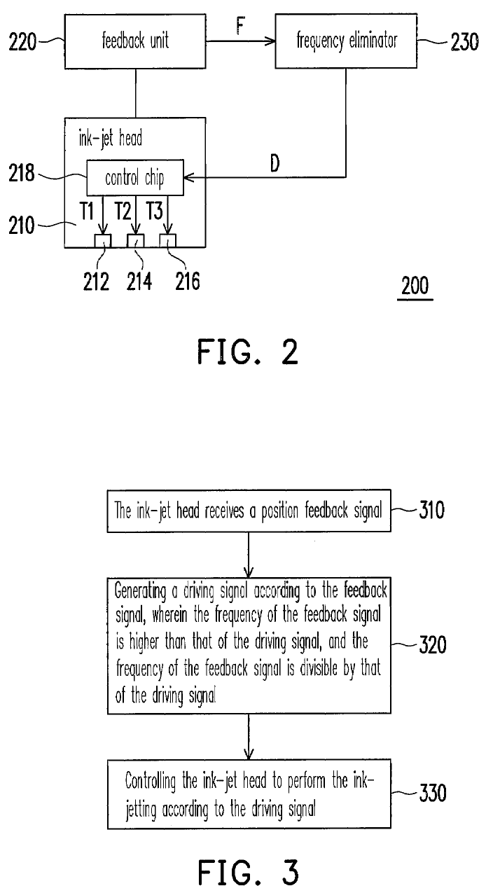

FIG. 2 is a block diagram of an ink-jet system according to a preferred embodiment of the present invention. As shown in FIG. 2, the ink-jet system 200 mainly includes an ink-jet head 210, a feedback unit 220 and a frequency eliminator 230. The ink-jet head 210 has at least one nozzle, and in the embodiment, the ink-jet head 210 having three nozzles 212, 214 and 216 is taken as an example. Moreover, the ink-jet head 210 has a control chip 218 for controlling the nozzles 212, 214 and 216 to perform the ink-jetting. The feedback unit 220 is coupled to the ink-jet system 200, so as to provide a feedback signal 310 to the ink-jet head 210. The frequency eliminator 230 is coupled between the feedback unit 220 and the control chip 218 of the ink-jet head 210, so as to perform the frequency eliminating on the feedback signal F, and to output a driving signal D to the control chip 218, and thereby controlling the ink-jet head 210 to perform the ink-jetting.

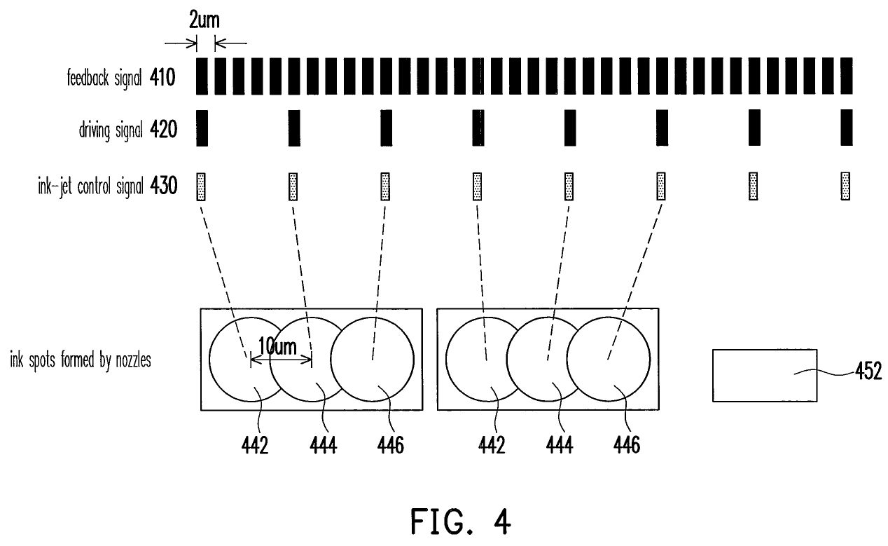

Referring to FIG. 2 and FIG. 3, FIG. 3 shows an ink-jet control method of the present invention that is suitable for being used in the ink-jet system. When performing the ink-jet control, firstly, the ink-jet head 210 receives a position feedback signal (step 310). In the embodiment, the feedback unit 220 is used to read the ink-jet printing position of the ink-jet head 210, wherein the adopted feedback unit 220 is, for example, a function generator, an optical scale or a rotary encoder, and used for outputting a corresponding feedback signal F to the frequency eliminator 230 according to the ink-jet printing position of the ink-jet head 210.

Next, as shown in step 320, the frequency eliminator 230 is used to perform the frequency eliminating to the feedback signal F, so as to generate a driving signal D according to the feedback signal F, wherein the frequency of the feedback signal F needs to be higher than that of the driving signal D, and the frequency of the feedback signal F is divisible by that of the driving signal D. In the present invention, the frequency eliminator 230 is a flip-flop device, a counter or other known circuits or elements that can achieve the same effect. The frequency eliminating step mainly aims at changing the feedback signal F with a relatively high frequency to a triggering clock with a relatively low frequency and then outputting the feedback signal F, wherein the frequency of the triggering clock is the desired ink-jetting frequency. Therefore, in the present invention, the driving signal D with an appropriate triggering clock may be obtained through the frequency eliminating operation according to the required pattern resolution. It should be noted that, the frequency of the feedback signal F depends on the ink-jet printing resolution of the feedback unit 220 when the ink-jet head 210 performs the ink-jet printing. As for selecting the resolution of the feedback unit 220, the desired operating frequency, the pattern resolution and the cost of the ink-jet control should be considered.

Then, as shown in step 330, after receiving the driving signal D, the control chip 218 of the ink-jet head 210 controls the ink-jet head 210 to perform the ink-jetting. Particularly, the ink-jet head 210 having three nozzles 212, 212 and 216 is taken as an example in the embodiment, and the control chip 218 outputs the ink-jet control signals T1, T2 and T3 to the corresponding nozzles 212, 214 and 216 according to the driving signal D, so as to control the nozzles 212, 214 and 216 to perform the ink-jetting.

The feedback signal F, the driving signal D and the ink-jet control signals T1-T3 are pulse signals, and their wave forms may be a square wave, a sine wave, a triangular wave, a trapezoidal wave or any combination thereof, which is not limited in the present invention.

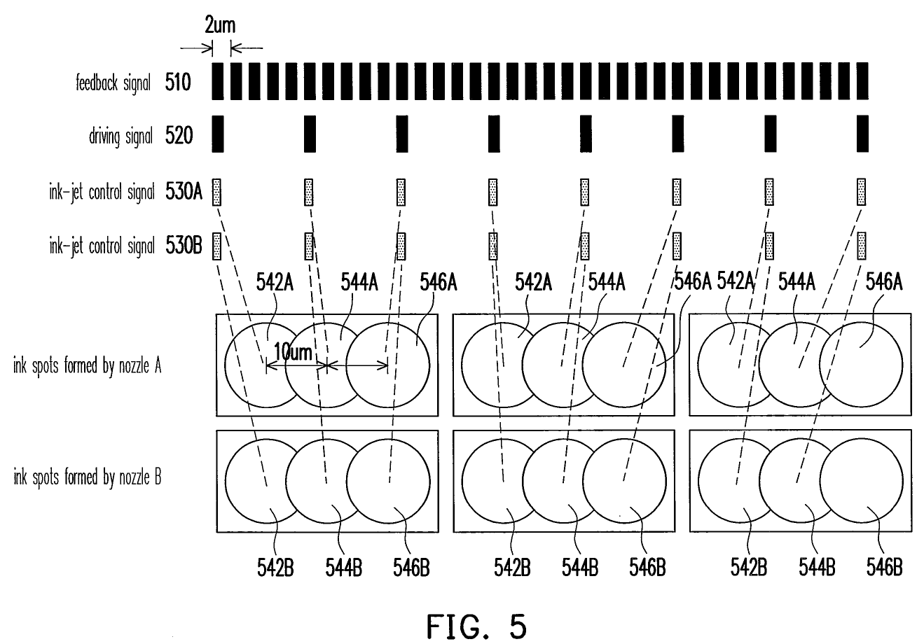

The corresponding relationship between the signal and the ink-jet pattern in an ink-jet control method of the present invention is further demonstrated below with reference to FIG. 4. As shown in FIG. 4, in order to be used in the subsequent frequency eliminating operation, the feedback unit with a relatively high resolution is selected in the embodiment, so as to generate a high frequency feedback signal 410 according to the ink-jet printing position of the ink-jet head, and the resolution of the feedback signal 410 generated by way of the position control is, for example, only about 2 μm. If it is intended to obtain ink spots with an interval of 10 μm the same as that of the conventional art, the driving signal 420 with a relatively low frequency is obtained through the frequency eliminating in the embodiment, wherein the frequency is ⅕ of that of the feedback signal 410, that is, the period of the driving signal 420 is 5 times of that of the feedback signal 410. Then, after the driving signal 420 has been inputted into the control chip of the ink-jet head, the ink-jet control signal 430 being synchronized with the driving signal 420 is output according to the driving signal 420, so as to control the nozzle of the ink-jet head to perform the ink-jetting, thus, ink spots with an adjacent interval of 10 μm is obtained. In the embodiment, each ink spots 442, 444 and 446 are synchronized with the feedback signal 410 to correspond to the pulse of the feedback signal 410 exactly, so as to obtain the accurate ink-jet position, and thereby forming a uniform ink-jet pattern 452.

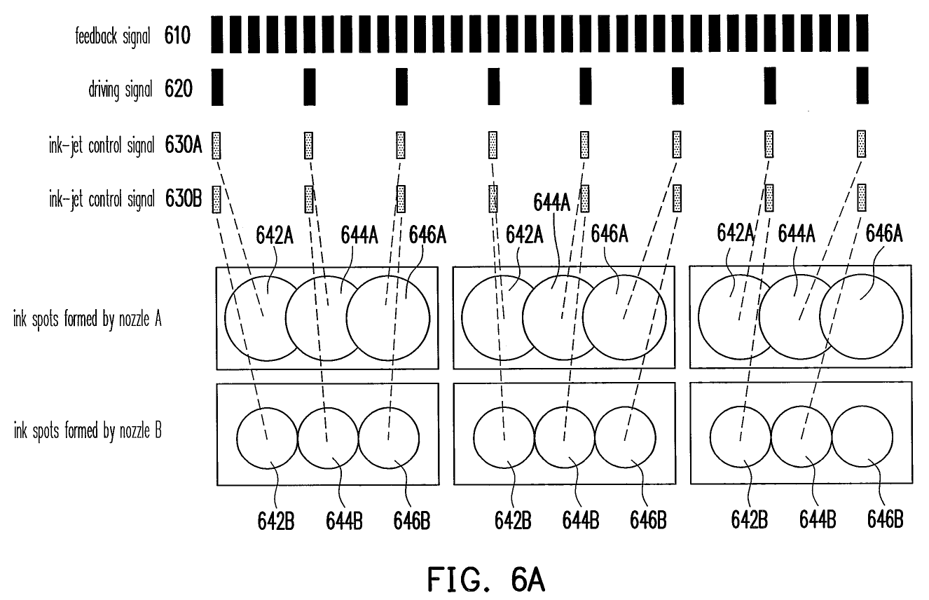

FIG. 5 shows a corresponding relationship between the signal and the ink-jet pattern in another ink-jet control method of the present invention. In the embodiment, each ink-jet head has a plurality of nozzles, for example, nozzles A and B, so after a feedback signal 510 has been received and then the frequency eliminating operation has been performed to the feedback signal 510 to obtain a driving signal 520, the control chip of the ink-jet head outputs ink-jet control signals 530A and 530B to the nozzles A and B respectively according to the driving signal 520, so as to control the nozzles A and B respectively to perform the ink-jetting. Similar to the above embodiment, the resolution of the feedback signal 510 is also set to be 2 μm in the embodiment, and the frequency of the driving signal 520 and the ink-jet control signals 530A, 530B is ⅕ of that of the feedback signal 510, so as to obtain ink spots 542A, 544A, 546A and 542B, 544B, 546B with the adjacent interval of 10 μm.

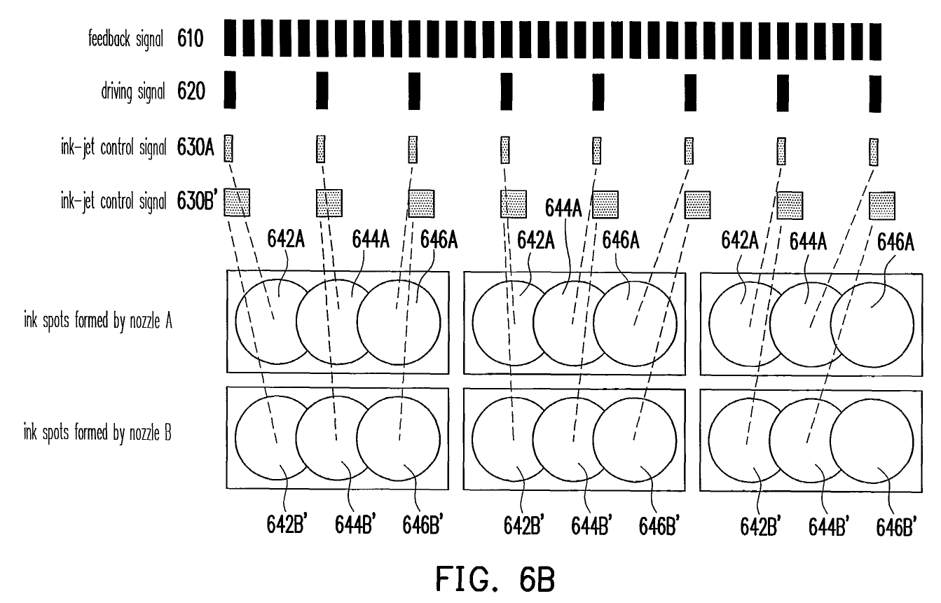

It should be noted that, due to the defects in the manufacturing process of the ink-jet head or the variation of the temperature and the pressure in the process of the ink-jet control, under the same driving control, the ink spots generated by different nozzles are different in size. FIG. 6A is a schematic view showing that when the ink-jet control method is adopted, the ink spots with different sizes are generated due to the defects of the ink-jet head. In order to solve the above problems, the individual ink-jet control signal corresponding to each nozzle can further be modulated in the present invention.

FIG. 6B shows a corresponding relationship between the signal and the ink-jet pattern after the ink-jet control method of FIG. 6A has been improved. Referring to FIGS. 6A and 6B, after a feedback signal 610 has been received and then the frequency eliminating operation has been performed to the feedback signal 610 to obtain a driving signal 620, the control chip of the ink-jet head outputs ink-jet control signals 630A and 630B respectively according to the driving signal 620. As shown in FIG. 6A, if the same ink-jet control signals 630A and 630B have been received, ink spots 642A, 644A, 646A generated by the nozzle A are larger than ink spots 642B, 644B, 646B generated by the nozzle B. Therefore, as shown in FIG. 6B, an addressable pulse width modulation is performed to the ink-jet control signal 630B in the embodiment, so as to obtain an ink-jet control signal 630B′ with a larger pulse width. Therefore, the ink-jet control signal 630B′ may be used to prolong the ink-jetting time of the nozzle B. In other words, the size of the ink spots 642B′, 644B′, 646B′ generated by the nozzle B may be adjusted to be equal to that of the ink spots 642A, 644A, 646A generated by the nozzle A.

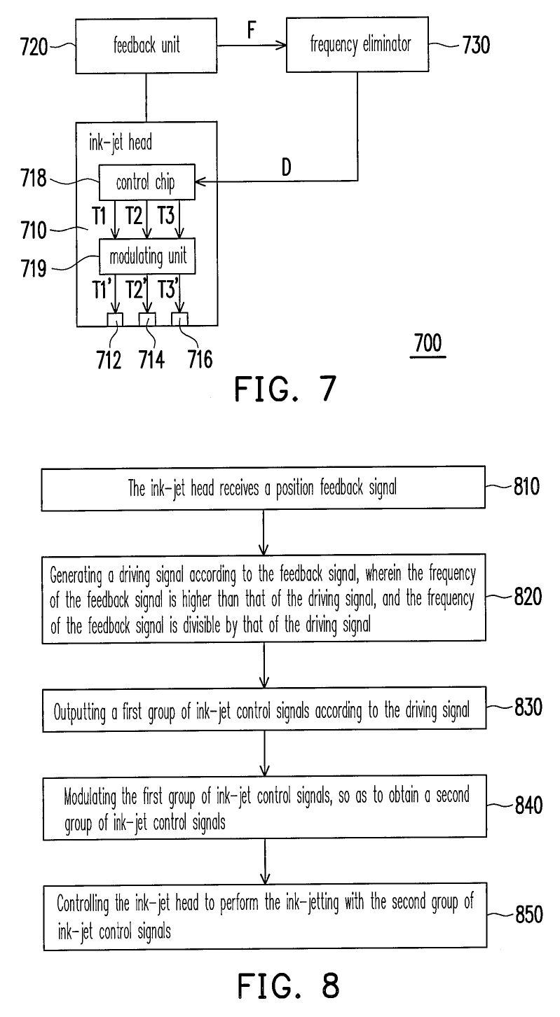

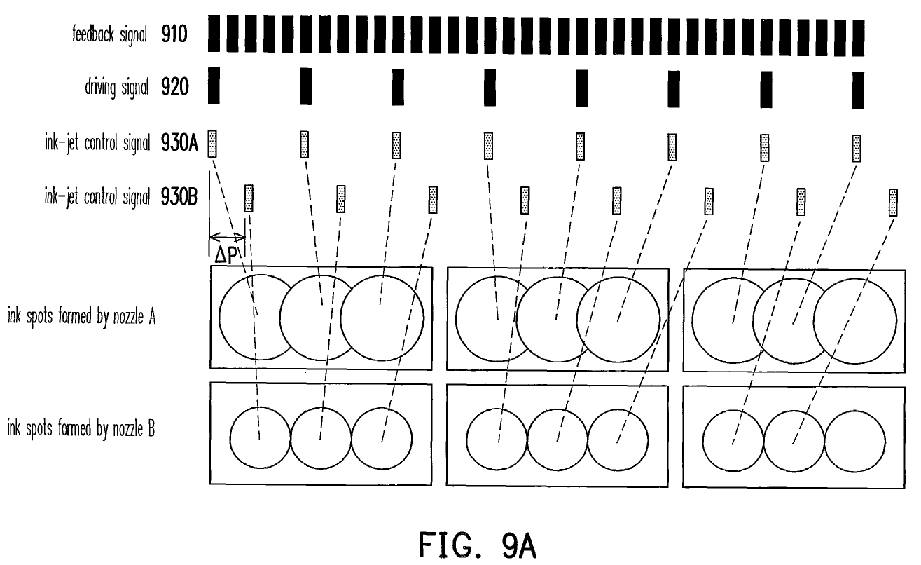

FIGS. 7 and 8 respectively show a block diagram and an ink-jet control method of an ink-jet system that is suitable for the driving method. As shown in FIGS. 7 and 8, an ink-jet system 700 mainly includes an ink-jet head 710, a feedback unit 720 and a frequency eliminator 730, wherein the ink-jet system 700 is similar to the ink-jet system 200 of FIG. 2, and a part of the components can be obtained with reference to the descriptions of FIG. 2, which thus will not described herein any more. The feedback unit 720 is coupled to the ink-jet head 710, and as shown in step 810, the feedback unit 720 outputs a corresponding feedback signal F to the frequency eliminator 730 according to the ink-jet printing position of the ink-jet head 710. Then, as shown in step 820, the frequency eliminator 730 performs the frequency eliminating to the feedback signal F, so as to generate a driving signal D according to the feedback signal F, and then transmits the driving signal D to the control chip 718 of the ink-jet head 710. The frequency of the feedback signal F is higher than that of the driving signal D, and the frequency of the feedback signal F is divisible by that of the driving signal D. Then, as shown in step 830, after receiving the driving signal D, the control chip 718 outputs ink-jet control signals T1, T2 and T3 respectively, and as shown in step 840, the addressable pulse width modulation unit 719 is used to modulate at least one of the ink-jet control signals T1, T2 and T3, so as to obtain modulated ink-jet control signals T1′, T2′ and T3′. Then, as shown in step 850, the ink-jet control signals T1′, T2′ and T3′ are output to the corresponding nozzles 712, 714 and 716, so as to control the nozzles 712, 714 and 716 to perform the ink-jetting.

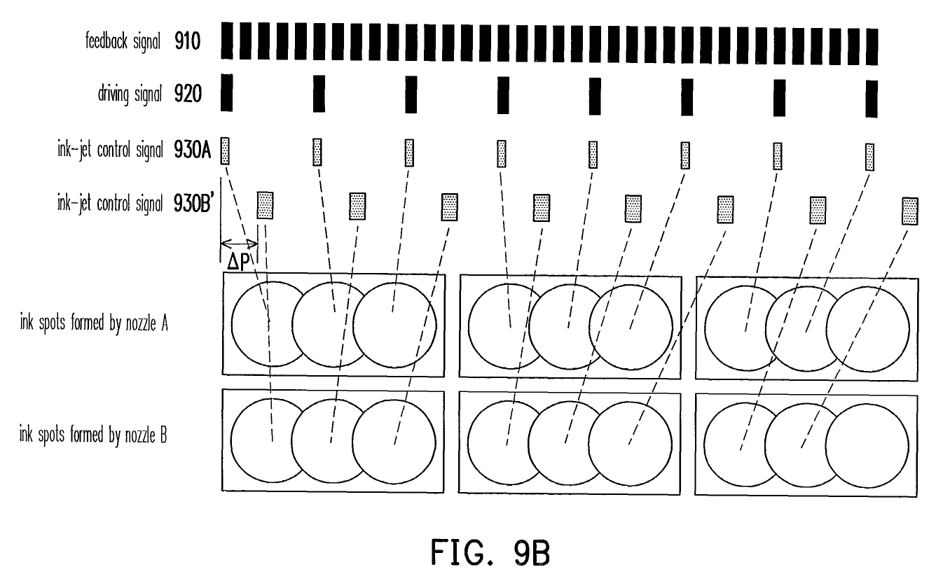

FIG. 9A shows a corresponding relationship between the signal and the ink-jet pattern in yet another ink-jet control method of the present invention. The control method adopted in the embodiment may not trigger all the nozzles on the same time, according to the asynchronous controlling requirements between different nozzles, e.g., the ink-jet controls in scan driving or changing of the ink-jet positions. To meet the above requirements, in the embodiment, for example, firstly, the feedback signal 910 is received; and then, the frequency eliminating operation is performed to the feedback signal 910, so as to obtain a driving signal 920; then, according to the driving signal 920, the ink-jet control signals 930A and 930B are asynchronously output in sequence to the nozzles A and B, wherein the ink-jet control signal 930A is synchronized with the driving signal 920, and the ink-jet control signal 930B has a phase difference ΔP with respect to the driving signal 920, so as to control the nozzles A and B in sequence to perform the ink-jetting. It should be noted that, the ink-jet control signals 930A and 930B of the embodiment are still synchronized with the feedback signal 910.

Moreover, if the above embodiment is combined with the ink-jet control method of FIGS. 6A and 6B, a corresponding relationship between the signal and the ink-jet pattern of another ink-jet control method is further obtained as shown in FIG. 9B. In the embodiment, besides the circumstance that the ink-jet control signals 930A and 930B are output asynchronously, the addressable pulse width modulation is performed to the ink-jet control signal 930B, so as to output an ink-jet control signal 930B′ with a relatively large pulse width. In this manner, the size of the ink spots formed by the nozzles A and B may be adjusted to make up for the printing problems caused by the manufacturing process defects.

Moreover, only two ink-jet control signals are taken as an example in the above embodiment, but if the ink-jet head has more than three nozzles, and more than three ink-jet control signals are applied, each ink-jet control signal may have the same or different phase difference with respect to the driving signal depending upon the designing requirements, which thus will not be described herein any more.

To sum up, the ink-jet control method and the ink-jet system of the present invention at least have the following features and advantages.

First, the frequency eliminating operation is performed to the feedback signal that controls the motion of the ink-jet head, so as to obtain the driving signal that is in accordance with the desired triggering frequency, thus, the problem of the slow processing speed of the chip caused by the excessively high frequency of the triggering signal under the high resolution motion control may be solved, so as to be helpful for enhancing the ink-jetting speed.

Second, the driving signals with different frequencies are obtained through the frequency eliminating according to the feedback signal, so as to satisfy different printing requirements, and thereby having a preferred compatibility.

Third, each ink spot corresponds to one triggering point of the driving signal, so as to meet the accurate requirements about the positions of the ink spots, which is helpful for enhancing the ink-jetting quality.

Fourth, due to the manufacturing process defects or the variations of the temperature and the pressure in the process of the ink-jet control, the ink-jet control signal corresponding to the nozzle is modulated, so as to change the size of the ink spot and thereby further enhancing the quality of the ink-jet pattern.

Fifth, the ink-jet control signals for different nozzles are output asynchronously to trigger the nozzles at different time, so as to meet the printing requirements such as the ink-jet control in scan driving or changing of the ink-jet positions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An ink-jet control method, suitable for controlling an ink-jet head to perform an ink-jetting, comprising:
providing a feedback signal to the ink-jet head;
generating a driving signal according to the feedback signal, wherein the frequency of the feedback signal is higher than that of the driving signal, and the frequency of the feedback signal is divisible by that of the driving signal; and
controlling the ink-jet head to perform the ink-jetting according to the driving signal.

2. The ink-jet control method as claimed in claim 1, wherein the method of generating the driving signal comprises using a flip-flop device or a counter to perform a frequency eliminating to the feedback signal.

3. The ink-jet control method as claimed in claim 1, wherein the feedback signal is generated from a function generator, an optical scale or a rotary encoder that performs a feedback control to the ink-jet head.

4. The ink-jet control method as claimed in claim 1, wherein the ink-jet head has a nozzle, and after receiving the driving signal, the ink-jet head outputs an ink-jet control signal to the nozzle according to the driving signal.

5. The ink-jet control method as claimed in claim 1, wherein the ink-jet head has a plurality of nozzles, and after receiving the driving signal, the ink-jet head outputs an ink-jet control signal to each nozzle respectively according to the driving signal.

6. The ink-jet control method as claimed in claim 5, wherein the ink-jet control signals are synchronized or not synchronized with the driving signal.

7. The ink-jet control method as claimed in claim 6, wherein when the ink-jet control signals are not synchronized with the driving signal, the ink-jet control signals have the same phase or different phase difference with respect to the driving signal.

8. The ink-jet control method as claimed in claim 5, wherein when the ink-jet head outputs the ink-jet control signals according to the driving signal, the method further comprises modulating at least one ink-jet control signal.

9. The ink-jet control method as claimed in claim 8, wherein the modulation performed to the ink-jet control signal comprises an addressable pulse width modulation.

10. The ink-jet control method as claimed in claim 5, wherein wave forms of the ink-jet control signals, the feedback signal and the driving signal include a square wave, a sine wave, a triangular wave, a trapezoidal wave or any combination thereof.

11. An ink-jet system, comprising:
an ink-jet head;
a feedback unit, for providing a feedback signal to the ink-jet head when the ink-jet head performs an ink-jet printing; and
a frequency eliminator, for performing a frequency eliminating to the feedback signal, and generating a driving signal, so as to control the ink-jet head to perform the ink-jetting according to the driving signal, wherein the frequency of the feedback signal is higher than that of the driving signal, and the frequency of the feedback signal is divisible by that of the driving signal.

12. The ink-jet system as claimed in claim 11, wherein the feedback unit comprises a function generator, an optical scale or a rotary encoder.

13. The ink-jet system as claimed in claim 11, wherein the frequency eliminator comprises a flip-flop device or a counter.

14. The ink-jet system as claimed in claim 11, wherein the ink-jet head has a nozzle, and after receiving the driving signal, the ink-jet head outputs an ink-jet control signal to the nozzle according to the driving signal.

15. The ink-jet system as claimed in claim 11, wherein the ink-jet head has a plurality of nozzles, and after receiving the driving signal, the ink-jet head outputs an ink-jet control signal to each nozzle respectively according to the driving signal.

16. The ink-jet system as claimed in claim 15, wherein the ink-jet control signals are synchronized or not synchronized with the driving signal.

17. The ink-jet system as claimed in claim 16, wherein when the ink-jet control signals are not synchronized with the driving signal, the ink-jet control signals have the same phase or different phase difference with respect to the driving signal.

18. The ink-jet system as claimed in claim 15, wherein the ink-jet head further has a modulating unit for modulating at least one ink-jet control signal when outputting ink-jet control signals.

19. The ink-jet system as claimed in claim 18, wherein the modulating unit is an addressable pulse width modulation unit.

20. The ink-jet system as claimed in claim 15, wherein wave forms of the ink-jet control signals, the feedback signal and the driving signal include a square wave, a sine wave, a triangular wave, a trapezoidal wave or any combination thereof.
